(19) United States
(12) Patent Application Publication
(10) Pub. No.: US 2008/0233877 A1
(43) Pub. Date: Sep. 25, 2008

(54) METHOD OF CONNECTING A BLUETOOTH HEADPHONE TO BLUETOOTH COMMUNICATIONS DEVICES

(76) Inventor: Lin-kar Gwee, Maryland points (SG)

Correspondence Address: SAM CHEN, 7F-1, 293, ROOSEVELT ROAD, SEC 3, TAIPEI, TW

(21) Appl. No.: 11/688,259

(22) Filed: Mar. 20, 2007

(51) Int. Cl. H04B 7/00

(52) U.S. Cl. 455/41.3

(57) ABSTRACT

A method of connecting a Bluetooth headphone to Bluetooth communications devices includes paring; initializing the Bluetooth headphone comprising creating a table having a first column of rfcomm channel associated with the Bluetooth communications device and a second column of instance corresponding to the rfcomm channel, setting a HS or HF mode of Bluetooth, and causing the Bluetooth headphone to be ready; and connection establishment which, in one embodiment, is initiated by one Bluetooth communications device by checking data, establishing an instance associated with one Bluetooth communications device, establishing a corresponding rfcomm channel, filling the rfcomm channel and the instance in the table, and establishing a connection of one Bluetooth communications device and the Bluetooth headphone.

### BACKGROUND OF THE INVENTION

1. Field of Invention

The invention relates to Bluetooth technology and more particularly to a method of connecting a Bluetooth headphone to many Bluetooth communications devices (e.g., mobile phones and the like).

2. Description of Related Art

Conventionally, paring is made between a Bluetooth headphone and a single mobile phone. Also, it is possible that a person may possess more than one mobile phone. Thus, a plurality of Bluetooth headphones are required if a plurality of mobile phones are trying to communicate with the Bluetooth headphones at the same time. This is not convenient. Hence, the conventional Bluetooth headphone arrangement cannot satisfy the needs.

Taiwanese Publication Application No. 91,133,651 discloses an apparatus for switching connection between a Bluetooth headphone and any one of Bluetooth communications devices and control method therefor as depicted in FIG. 1. As shown, a solid line means a connection between a Bluetooth headphone A and a Bluetooth communications device (e.g., mobile phone) B1 (i.e., a pair) and a dash line means a disconnection between the Bluetooth headphone A and a Bluetooth communications device (e.g., mobile phone) B or B2. In a connection switching operation, the connection between the Bluetooth headphone A and the mobile phone B1 is required to disconnect (i.e., delete) prior to, for example, establishing a connection between the Bluetooth headphone A and the mobile phone B2.

The above technique eliminates the needs of a plurality of Bluetooth headphones. However, it is a time consuming process of deleting an existing pair and establishing a new pair in each connection switching operation. Thus, it is desirable to provide a novel method of connecting a Bluetooth headphone to many Bluetooth communications devices in order to overcome the drawback of the prior art.

### SUMMARY OF THE INVENTION

It is therefore one object of the invention to provide a method of connecting a Bluetooth headphone to Bluetooth communications devices comprising paring; initializing the Bluetooth headphone comprising creating a table having a first column of rfcomm channel associated with the Bluetooth communications device and a second column of instance corresponding to the rfcomm channel, setting a HS or HF mode of Bluetooth, and causing the Bluetooth headphone to be ready; and connection establishment which, in one embodiment, is initiated by one Bluetooth communications device by checking data, establishing an instance associated with one Bluetooth communications device, establishing a corresponding rfcomm channel, filling the rfcomm channel and the instance in the table, and establishing a connection of one Bluetooth communications device and the Bluetooth headphone.

The above and other objects, features and advantages of the invention will become apparent from the following detailed description taken with the accompanying drawings.

### BRIEF DESCRIPTION OF THE DRAWINGS

FIG. 1 depicts a conventional connection between a Bluetooth headphone and a Bluetooth communications device and disconnections between the Bluetooth headphone and other Bluetooth communications devices;

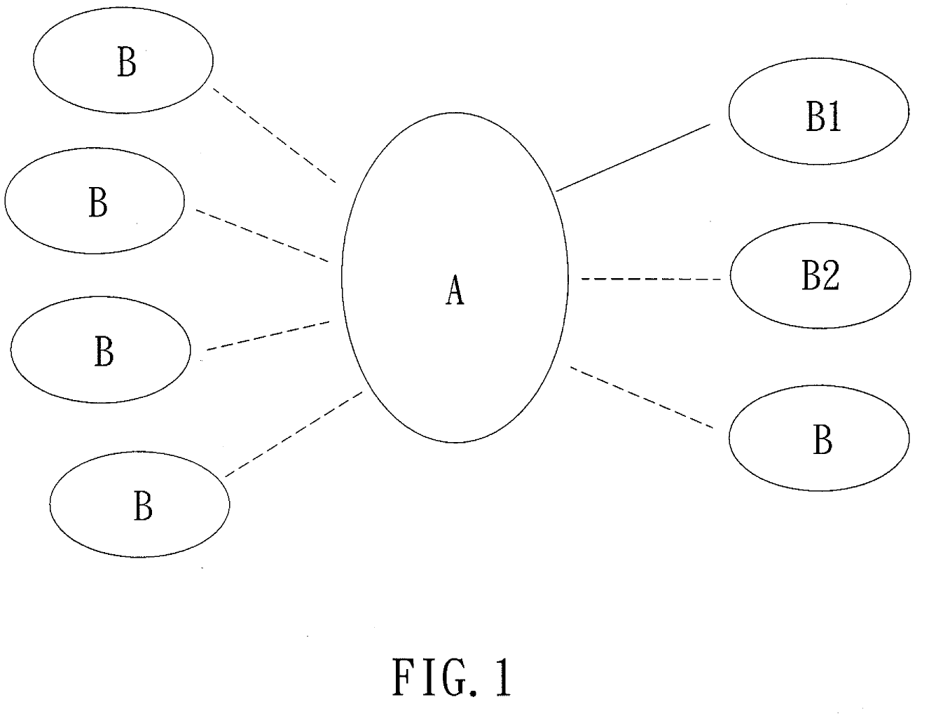

FIG. 2 depicts paring between a Bluetooth headphone and Bluetooth communications devices according to a method of the invention;

FIG. 3 is a flowchart depicting a process of initializing the Bluetooth headphone according to the method of the invention;

FIG. 4 is an empty table created according to the method of the invention;

FIG. 5 is a flowchart depicting a process of establishing a connection as initiated by a Bluetooth communications device according to the method of the invention;

FIG. 6 is a flowchart depicting a process of establishing a connection as initiated by a Bluetooth headphone according to the method of the invention;

FIG. 7 is the table of FIG. 4 being filled with data by repeating the connection steps illustrated in FIG. 5, FIG. 6, or both;

FIG. 8 is a flowchart depicting a process of sending data from the Bluetooth communications device to the Bluetooth headphone according to the method of the invention;

FIG. 9 is a flowchart depicting a process of sending data from the Bluetooth headphone to the Bluetooth communications device according to the method of the invention;

FIG. 10 is a flowchart depicting a process of disconnection according to the method of the invention; and

FIG. 11 depicts a connection between the Bluetooth headphone and the Bluetooth communications devices according to the method of invention.

### DETAILED DESCRIPTION OF THE INVENTION

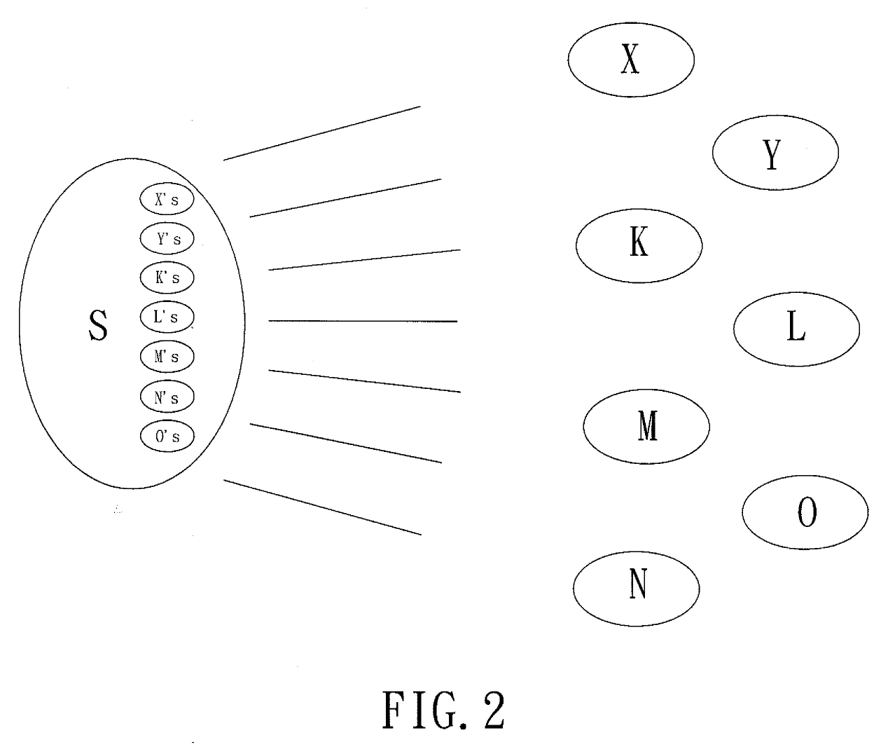

Referring to FIG. 2, paring between a Bluetooth headphone S and each of a plurality of Bluetooth communications devices X, Y, O, K, L, M, and N in accordance with a method of the invention is shown. As a result, pairs X's, Y's, O's, K's, L's, M's, and N's are schematically shown.

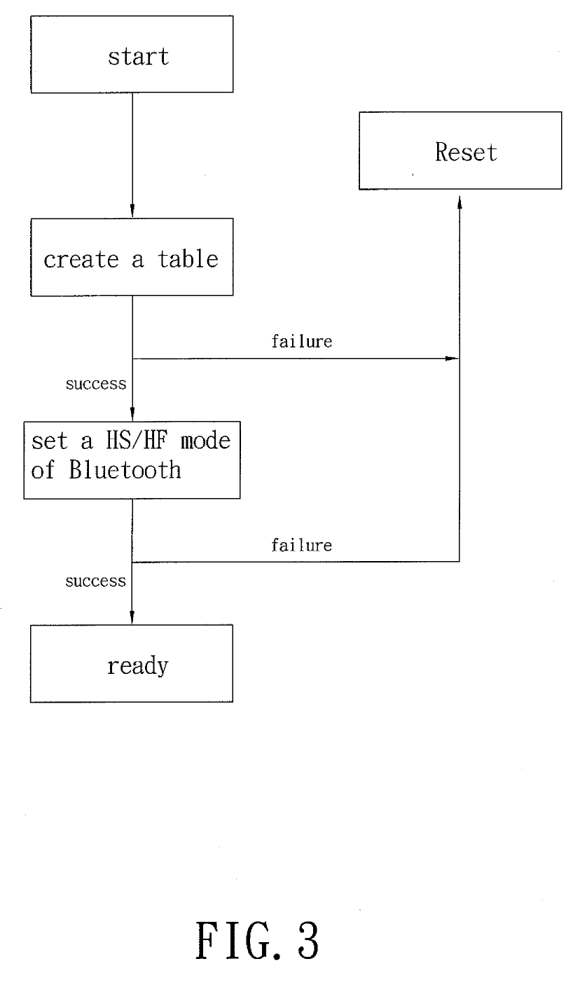

Referring to FIG. 3, a process of initializing the Bluetooth headphone S is illustrated. First, an empty table is created. Next, a HS (high-speed) or HF (high-frequency) mode of Bluetooth is about to set if the table is successfully created. Otherwise, the process goes to reset. Next, the process goes to ready mode (i.e., the Bluetooth headphone S is ready) if HS or HF mode of Bluetooth is set. Otherwise, the process goes to reset.

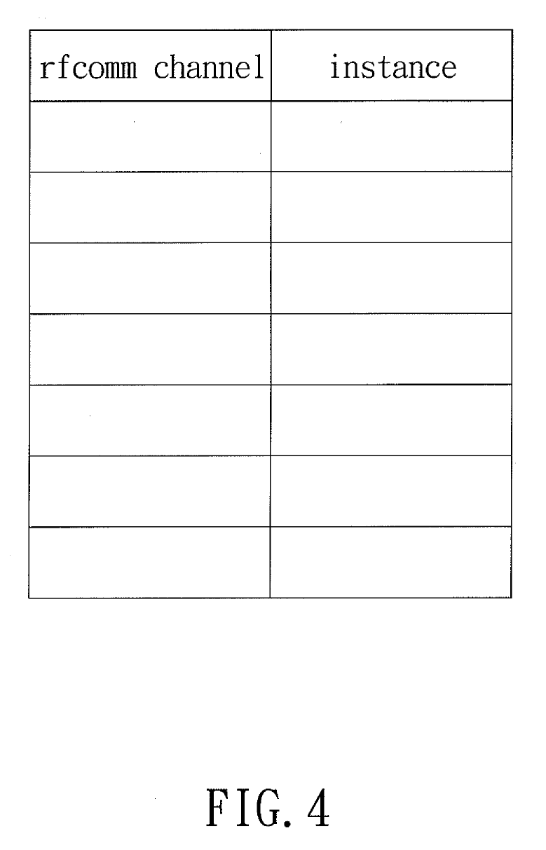

Referring to FIG. 4, the empty table is shown in which rfcomm channel represents a channel associated with a Bluetooth communications device and instance represents an instance corresponding to the rfcomm channel of the same row.

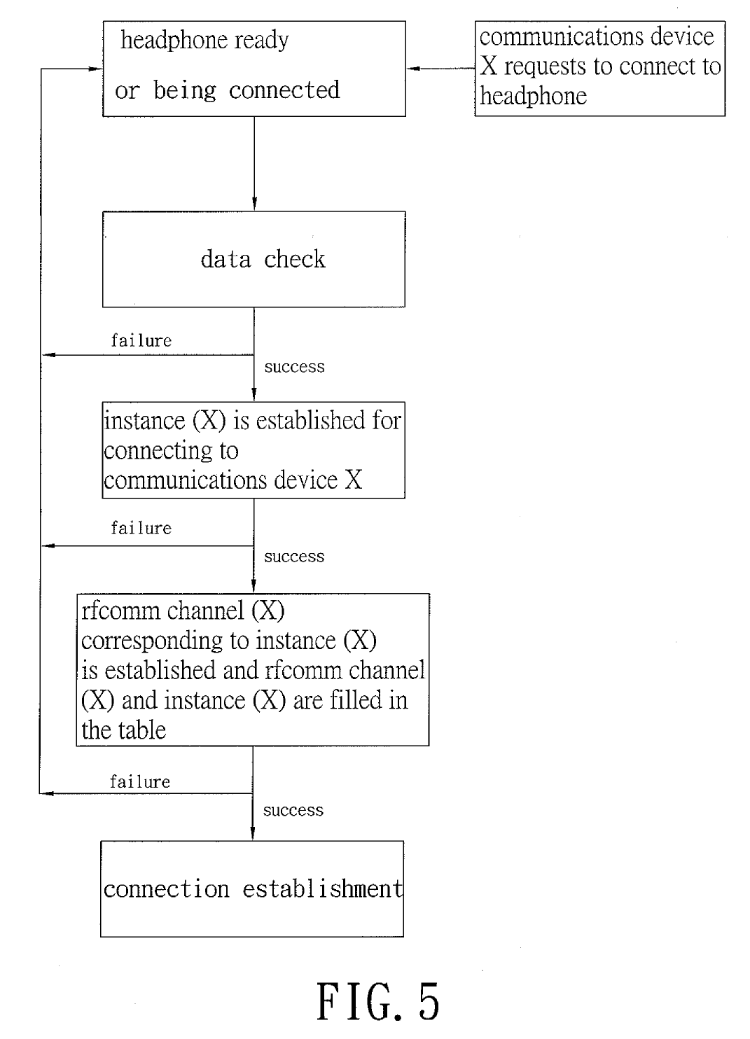

Referring to FIG. 5, a process of establishing a connection as initiated by a Bluetooth communications device is illustrated. (a) The Bluetooth headphone S is ready or is being connected to a Bluetooth communications device. (b) Another Bluetooth communications device X requests to connect to the Bluetooth headphone S. (c) Next, data is checked. (d) An instance (X) is established by the Bluetooth headphone S for connecting to the Bluetooth communications device X if the data check is a success. Otherwise, the process loops back to step (a). (e) A rfcomm channel (X) corresponding to instance (X) is established by the Bluetooth headphone S and both rfcomm channel (X) and instance (X) are filled in blanks of the same row of the table. (f) The process goes to connection establishment if step (e) is a success. Otherwise, the process loops back to step (a).

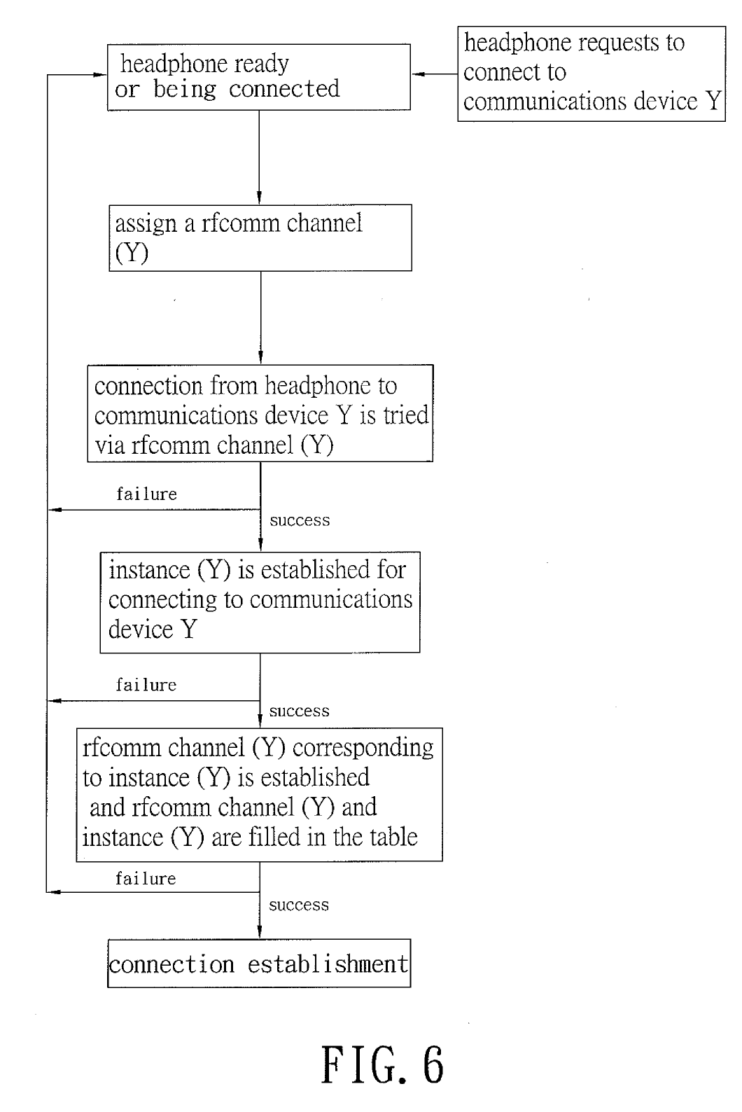

Referring to FIG. 6, a process of establishing a connection as initiated by a Bluetooth headphone is illustrated. (a) The Bluetooth headphone S is ready or is being connected to a Bluetooth communications device. (b) The Bluetooth headphone S requests to connect to another Bluetooth communications device Y. (c) Next, a rfcomm channel (Y) is assigned. (d) A connection from the Bluetooth headphone S to the Bluetooth communications device Y is tried via the rfcomm channel (Y). (e) An instance (Y) is established by the Bluetooth headphone S for connecting to the Bluetooth communications device Y if the trying is a success. Otherwise, the process loops back to step (a). (f) A rfcomm channel (Y) corresponding to instance (Y) is established by the Bluetooth headphone S and both rfcomm channel (Y) and instance (Y) are filled in blanks of the same row of the table. (g) The process goes to connection establishment if step (f) is a success. Otherwise, the process loops back to step (a).

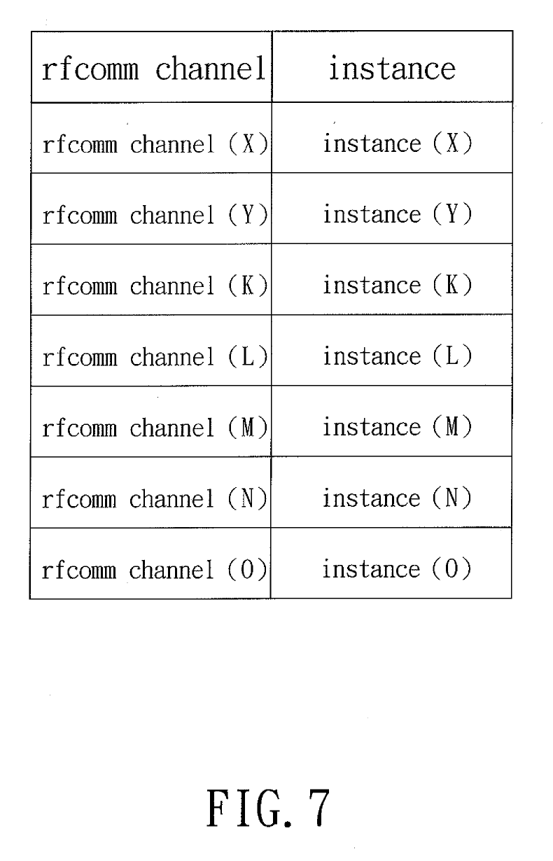

Referring to FIG. 7, a complete table is created by repeating steps illustrated in FIG. 5, FIG. 6 or both. This means that the single Bluetooth headphone S is capable of connecting to the plurality of Bluetooth communications devices X, Y, K, L, M, N, and O.

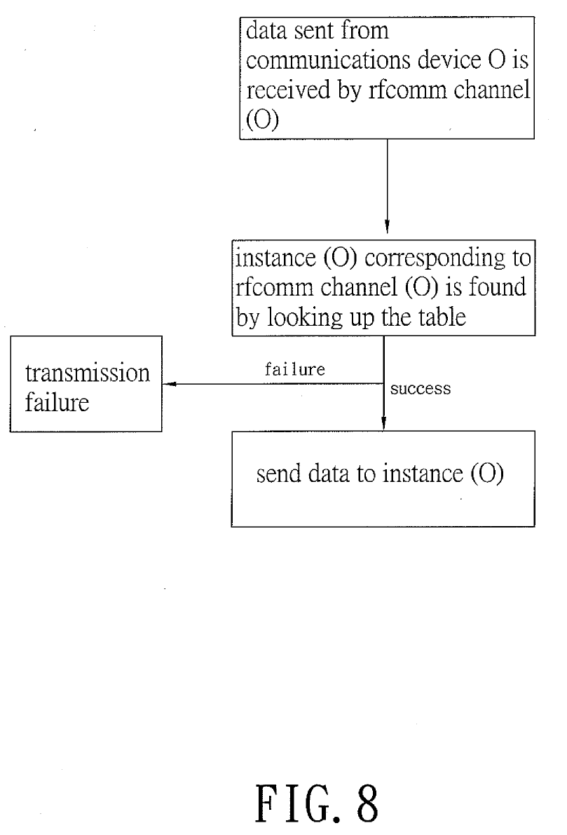

Referring to FIG. 8, a process of sending data from the Bluetooth communications device O to the Bluetooth headphone S is illustrated. (a) First, data sent from the Bluetooth communications device O is received by the rfcomm channel (O). (b) A corresponding instance (O) is found by looking up the table (i.e., the instance (O) is associated with the rfcomm channel (O)). (c) Send data to the instance (O) if the corresponding instance (O) is successfully found. Otherwise, the process fails.

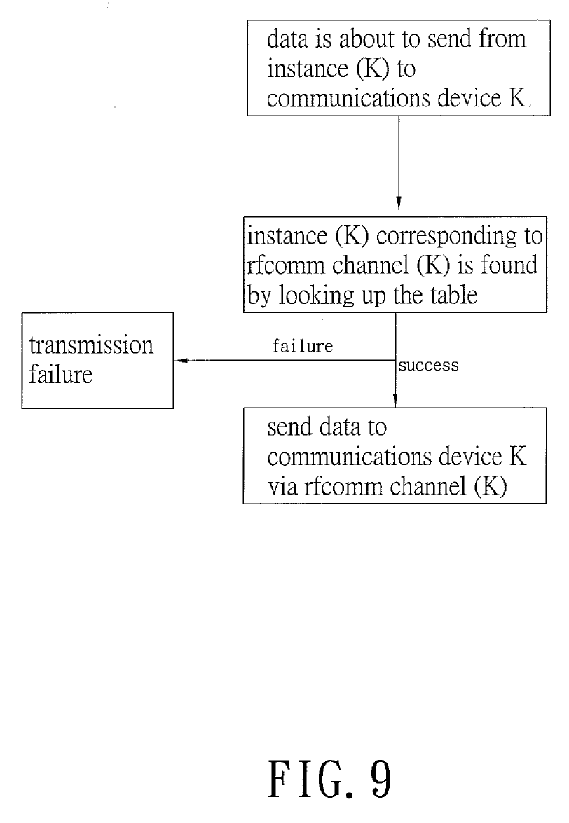

Referring to FIG. 9, a process of sending data from the Bluetooth headphone S to the Bluetooth communications device K is illustrated. (a) First, data is about to send from the instance (K) to the Bluetooth communications device K. (b) A corresponding rfcomm channel (K) is found by looking up the table (i.e., the instance (K) is associated with the rfcomm channel (K)). (c) Send data to the Bluetooth communications device K via the rfcomm channel (K) if the corresponding rfcomm channel (K) is successfully found. Otherwise, the process fails.

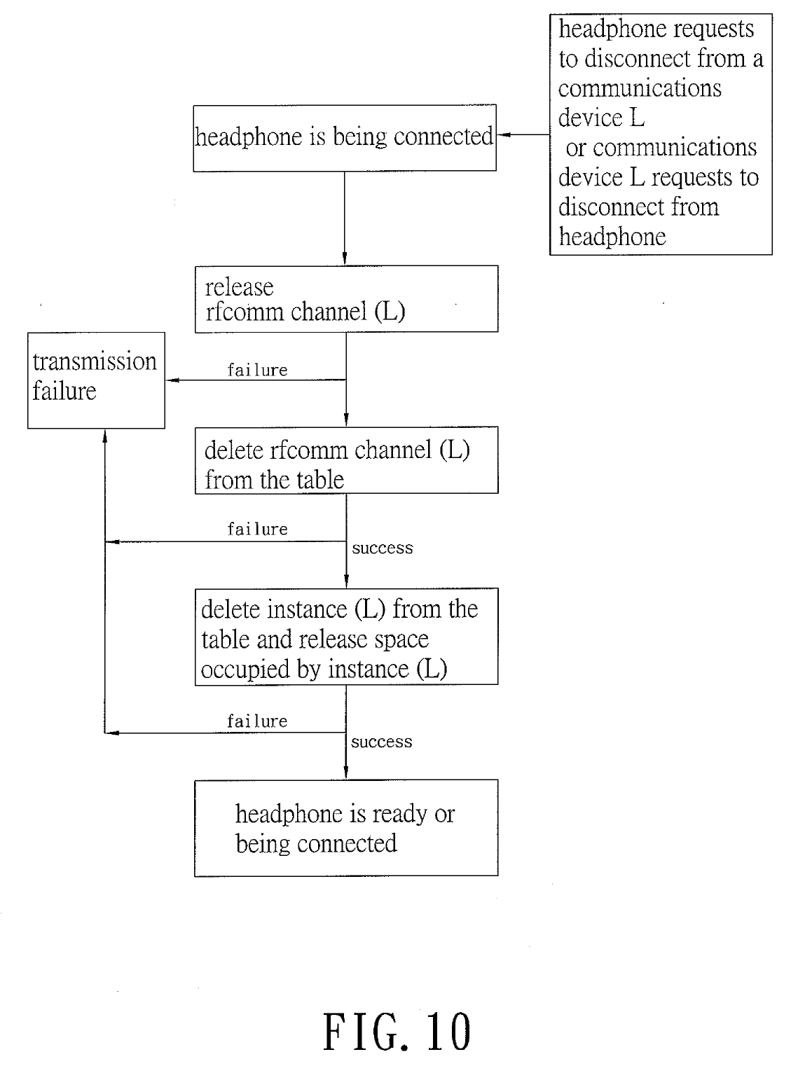

Referring to FIG. 10, a process of disconnection is illustrated. (a) The Bluetooth headphone S is being connected to at least one Bluetooth communications device. (b) The Bluetooth headphone S requests to disconnect from a Bluetooth communications device L or the Bluetooth communications device L requests to disconnect from the Bluetooth headphone S. (c) The rfcomm channel (L) is released. Otherwise, the process fails. (d) The rfcomm channel (L) is deleted from the table. Otherwise, the process fails. (e) The instance (L) is deleted from the table and space occupied by the instance (L) is released. Otherwise, the process fails (f) The Bluetooth headphone S is ready or is being connected to other Bluetooth communications device(s).

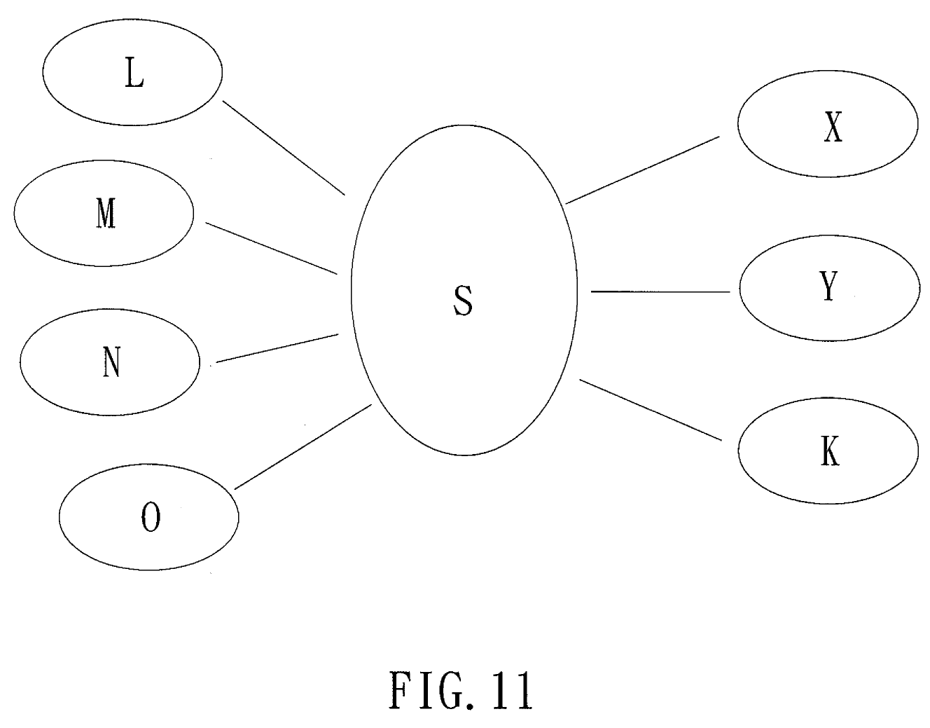

Referring to FIG. 11, a connection between the Bluetooth headphone A and the Bluetooth communications devices L, M, N, O, X, Y, and K is shown.

The Bluetooth communications device can be a Bluetooth mobile phone, a personal computer having VoIP (Voice over Internet Protocol) feature, or a PDA (Personal Digital Assistant).

While the invention herein disclosed has been described by means of specific embodiments, numerous modifications and variations could be made thereto by those skilled in the art without departing from the scope and spirit of the invention set forth in the claims.

What is claimed is:

1. A method of connecting a Bluetooth headphone to a plurality of Bluetooth communications devices, comprising the steps of:
making pairs between the Bluetooth headphone and each of the Bluetooth communications devices;
initializing the Bluetooth headphone comprising trying to create a table including first and second columns and a plurality of rows until it succeeds, trying to set a HS (high-speed) mode or a HF (high-frequency) mode of Bluetooth until it succeeds, and causing the Bluetooth headphone to be ready if the HS or the HF mode of Bluetooth setting succeeds wherein the first column is a rfcomm channel associated with one of the Bluetooth communications devices and the second column is an instance corresponding to the rfcomm channel of the same row; and
connection establishment initiated either by one of the Bluetooth communications devices comprising requesting one of the Bluetooth communications devices not connecting to the Bluetooth headphone to connect to the Bluetooth headphone, checking data for confirmation, trying to establish an instance associated with one of the Bluetooth communications devices by the Bluetooth headphone until it succeeds, trying to establish a rfcomm channel corresponding to the instance by the Bluetooth headphone until it succeeds, filling the rfcomm channel and the instance in blanks of the same row of the table, and establishing a connection of one of the Bluetooth communications devices and the Bluetooth headphone; or by the Bluetooth headphone comprising requesting the Bluetooth headphone to connect another Bluetooth communications device, assigning a rfcomm channel associated with the another Bluetooth communications device, trying to establish a connection from the Bluetooth headphone to the another Bluetooth communications device via the rfcomm channel until it succeeds, trying to create an instance associated with the another Bluetooth communications device by the Bluetooth headphone until it succeeds, trying to create a rfcomm channel corresponding to the instance by the Bluetooth headphone until it succeeds, filling the rfcomm channel and the instance in blanks of the same row of the table, and establishing a connection of the another Bluetooth communications device and the Bluetooth headphone.

2. The method of claim 1, further comprising the step of sending data from one of the Bluetooth communications devices to the Bluetooth headphone by causing a rfcomm channel associated with one of the Bluetooth communications devices to receive data sent from one of the Bluetooth communications devices, looking up the table to find an instance corresponding to the rfcomm channel, and sending data to the instance.

3. The method of claim 1, further comprising the step of sending data from the Bluetooth headphone to one of the Bluetooth communications devices by looking up the table to find a rfcomm channel corresponding to an instance which is served as a data sending source, and sending data from the instance to one of the Bluetooth communications devices via the rfcomm channel.

4. The method of claim 1, further comprising the step of disconnecting the Bluetooth headphone from one of the Bluetooth communications devices as requested by either the Bluetooth headphone or one of the Bluetooth communications devices by trying to release a rfcomm channel associated with one of the Bluetooth communications devices until it succeeds, trying to delete the rfcomm channel from the table until it succeeds, trying to delete an instance corresponding to the rfcomm channel from the table and release a space occupied by the deleted instance until it succeeds, and maintaining the Bluetooth headphone in a ready state.

5. The method of claim 1, wherein the Bluetooth communications device is a Bluetooth mobile phone, a personal computer having VoIP (Voice over Internet Protocol) capability, or a PDA (Personal Digital Assistant).
